(19) United States
(12) Patent Application Publication
(10) Pub. No.: US 2011/0232613 A1
(43) Pub. Date: Sep. 29, 2011

(54) Motor Vehicle Having an Exhaust Gas System

(76) Inventors: Uwe Sailer, Sinsheim (DE); Hubert Vollmer, Sao Paulo (BR)

(21) Appl. No.: 13/014,131

(22) Filed: Jan. 26, 2011

(30) Foreign Application Priority Data
Jan. 27, 2010 (DE) 10 2010 005 803.3

(51) Int. Cl. F02M 25/07; F02B 47/08

(52) U.S. Cl. 123/568.12

(57) ABSTRACT

The invention relates to a motor vehicle having an internal combustion engine and an exhaust gas system with an exhaust gas line by means of which exhaust gas from the internal combustion engine can be discharged, and an exhaust gas recirculation line by means of which exhaust gas from the exhaust gas line can be recirculated to an intake manifold of the internal combustion engine. In the exhaust gas recirculation line, there is an exhaust gas cooler which can move relative to the internal combustion engine. Due to the relative mobility, the exhaust gas cooler can be located at a distance from the internal combustion engine so that direct delivery of heat from the internal combustion engine into the exhaust gas cooler is avoided. This improves the cooling performance of the exhaust gas cooler and enables the use of less heat-resistant materials. The invention furthermore relates to a method for operating such a motor vehicle in which a partial flow cross section of the exhaust gas cooler is cleared or closed depending on the operating state of the motor vehicle. This enables adaptation of the cooling performance of the exhaust gas cooler to the operating state of the motor vehicle.

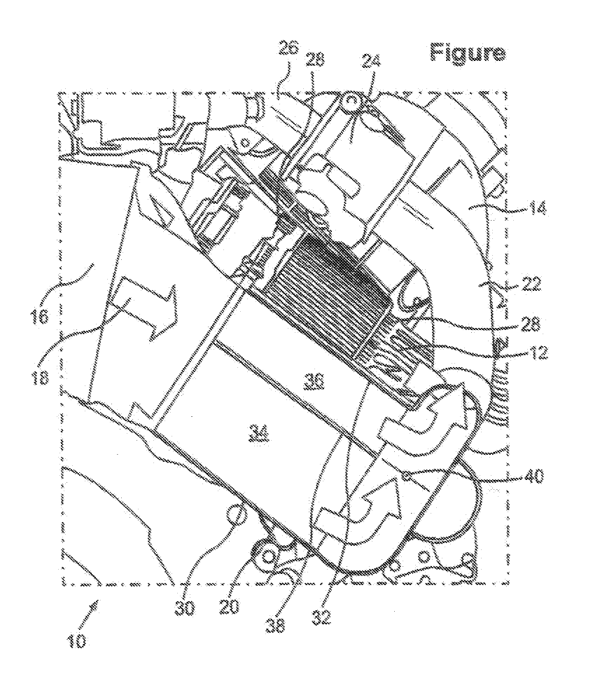

The invention relates to a motor vehicle having an exhaust gas system and a method for operating such a motor vehicle.

### BACKGROUND OF THE INVENTION

In order to decrease the emission of nitrogen oxides, modern motor vehicles often have an exhaust gas system with exhaust gas recirculation. In such exhaust gas systems, a partial quantity of the exhaust gas generated by an internal combustion engine of the motor vehicle is recirculated to the intake air of the internal combustion engine. The mixture of intake air and exhaust gas has a lower oxygen content than the pure intake air, as a result of which the combustion temperature in the internal combustion engine is lowered. The result of the lower combustion temperature is a decrease in the oxidation of nitrogen during the combustion process, thus lowering the production of environmentally harmful nitrogen oxides.

In gasoline engines, exhaust gas recirculation can also result in a reduction in the specific fuel consumption in partial load mode. The lower oxygen content of the mixture in the internal combustion engine allows the throttle valve to stay open longer in partial load mode so that back pressure losses that reduce the efficiency of the internal combustion engine are eliminated at the throttle valve.

An especially good effect of exhaust gas recirculation is obtained when the recirculated exhaust gas is cooled by means of an exhaust gas recirculation cooler, because, as the exhaust gas cools down, its density increases.

Typically, such exhaust gas coolers are rigidly connected to the internal combustion engine of the motor vehicle. An exhaust gas system with such an exhaust gas cooler is known, for example, from DE 100 28 400 A1. In such arrangements, heat, both from the exhaust gas and also directly from the internal combustion engine, is delivered into the exhaust gas cooler and into adjacent components. Therefore, there is a risk of overheating. Consequently, highly heat-resistant materials which are heavy and expensive must be used to build exhaust gas coolers and adjacent components of the exhaust gas system.

Thus, the object of this invention is to make available a method for operation of a motor vehicle by which the thermal load on the exhaust gas cooler and adjacent components is reduced.

### SUMMARY OF THE INVENTION

A motor vehicle according to the invention is characterized in that an exhaust gas cooler of an exhaust gas system can move relative to the internal combustion engine of the motor vehicle. The exhaust gas cooler can be connected to the internal combustion engine, for example, by means of flexible fasteners. Attachment of the exhaust gas cooler to other components of the motor vehicle which can move relative to the internal combustion engine is also possible. This entails a connection between the exhaust gas cooler and internal combustion engine only by lines for the recirculated exhaust gas which do not have a retaining function.

This makes it possible to mount the exhaust gas cooler at a distance from the internal combustion engine of the motor vehicle. Thus, a direct delivery of heat from the internal combustion engine into the exhaust gas cooler and adjacent components of the exhaust gas system is avoided. The exhaust gas cooler and adjacent components can thus be designed for a lower thermal burden. In particular, the use of less heat-resistant materials is possible. The exhaust gas system of such a motor vehicle can thus be produced especially economically and also has a low weight.

The reduced heat delivery into the exhaust gas cooler also improves its cooling performance compared to the prior art. The recirculated exhaust gas can thus be cooled to lower temperatures and therefore has a higher density. A motor vehicle according to the invention therefore has especially low nitrogen oxide emissions and can be operated with lower exhaust gas recirculation rates.

Preferably, the exhaust gas cooler is connected to the internal combustion engine via a flexible line. Such a line allows relative movements between the internal combustion engine and exhaust gas cooler. The exhaust gas cooler thus does not need to be supported jointly with the internal combustion engine. This allows an especially flexible arrangement of the exhaust gas cooler depending on the actual installation space circumstances in the motor vehicle.

The flexible line preferably consists of a nonmetallic material. Advantageously, materials are used for this purpose which have a lower inherent weight than metallic lines, such as, for example, plastics. Plastic lines are at the same time especially resistant to vibration loads as occur in operation of the motor vehicle.

In one preferred embodiment of the invention, there is an exhaust gas recirculation valve in the flow direction of the exhaust gas downstream of the exhaust gas cooler. The amount of the recirculated exhaust gas can be set as required depending on the operating state of the motor vehicle via such a valve. Here, it is especially advantageous to mount the exhaust gas recirculation valve fixed on the engine and to connect it to the exhaust gas cooler via the flexible line.

Preferably, the exhaust gas cooler has at least two heat exchangers which are separate from one another and which make available one flow channel each. The recirculated exhaust gas flows through the respective flow channels in parallel in at least one operating state of the motor vehicle. Such coolers have an especially good cooling performance in this operating state.

In one especially preferred embodiment, there is at least one closing element, by means of which an assigned flow channel of one heat exchanger can be closed. This enables an adjustment of the cooler network surface through which the exhaust gas flows and thus an adjustment of the cooling performance of the exhaust gas cooler overall. The temperature of the recirculated exhaust gas can thus be set depending on the operating state of the motor vehicle.

For example, it is possible to close off at least one of the heat exchangers in partial load mode of the motor vehicle in order to reduce the exhaust gas temperature less rapidly. This can prevent water from condensing out of the exhaust gas and damaging the components of the motor vehicle downstream of the cooler. In full load operation, the heat exchanger is opened, since in this operating state the exhaust gas emerges from the internal combustion engine with a higher temperature. The higher cooling performance of the exhaust gas cooler with the closing element open reduces the temperature of the recirculated exhaust gas more rapidly so that the thermal load on other components of the exhaust gas system, for example, a hose connection between the exhaust gas cooler and exhaust gas recirculation valve, is reduced.

The invention furthermore relates to a method for operating a motor vehicle in which a partial exhaust gas flow is removed from an exhaust gas line of an exhaust gas system, is cooled by means of an exhaust gas cooler, and is returned to the intake manifold of an internal combustion engine via a flexible line. Depending on the operating state of the motor vehicle, at least one partial flow cross section of the exhaust gas cooler is closed or cleared.

By means of closing or clearing at least one partial flow cross section of the exhaust gas cooler, its cooling performance can vary. Thus the temperature of the recirculated exhaust gas can be advantageously adapted to the respective operating state of the motor vehicle.

Preferably, at least one partial flow cross section of the exhaust gas cooler is closed when the exhaust gas cooler does not reach a specified exhaust gas mass flow and is cleared when a specified exhaust gas mass flow is exceeded. For small exhaust gas mass flows, a lower cooling performance of the exhaust gas cooler is required. Closing at least one partial flow cross section prevents the exhaust gas from being cooled too rapidly; this could lead to condensation of water in the exhaust gas cooler. At higher exhaust gas mass flows, a higher cooling performance of the exhaust gas cooler is made available by the method, as a result of which an overly high thermal load on the components of the exhaust gas system, especially of the flexible line, is counteracted.

The flow cross section of the exhaust gas cooler can also be set depending on the measured exhaust gas temperature. At a low exhaust gas temperature, at least one partial flow cross section is closed to reduce the cooling performance and to prevent condensate formation in the relatively cool exhaust gas; at a high exhaust gas temperature, at least one partial flow cross section is conversely cleared in order to counteract the thermal burden on the exhaust gas system by an increased cooling performance of the exhaust gas cooler.

The output of the internal combustion engine can also be used as a criterion for adjusting the cooling performance. At low output, a small amount of exhaust gas with a relatively low temperature is formed. In this operating state of the motor vehicle, at least one partial flow cross section of the exhaust gas cooler is closed, since only a small cooling performance is required for adequate cooling of the recirculated exhaust gas. At high output of the internal combustion engine, conversely, a large amount of exhaust gas with relatively high exhaust gas temperature is formed. At least one partial flow cross section of the exhaust gas cooler is opened here to increase the cooling performance and to prevent damage to the exhaust gas system by the high exhaust gas temperature.

### BRIEF DESCRIPTION OF THE DRAWING

The single FIGURE shows a perspective view of one partial region of the exhaust gas system for a motor vehicle according to the invention.

### DETAILED DESCRIPTION OF THE PREFERRED EMBODIMENTS OF THE INVENTION

An exhaust gas system which is designated as a whole as 10 for a motor vehicle comprises an exhaust gas line 12 by means of which exhaust gas is discharged from a internal combustion engine 14. A proportional amount of the exhaust gas is branched off by means of an exhaust gas recirculation line 16 which is connected to the exhaust gas line 12 and routed in the direction of the arrow 18 to an exhaust gas cooler 20. After flowing through the exhaust gas cooler 20, the exhaust gas travels via a flexible hose 22 and an exhaust gas recirculation valve 24 back into an intake manifold 26 of the internal combustion engine 14, where it is mixed with intaken combustion air. In this way, the oxygen content of the mixture burned in the internal combustion engine is reduced so that combustion proceeds at lower temperatures than the combustion with pure air. This reduces the formation of nitrogen oxides during the combustion.

The exhaust gas cooler 20 is rigidly connected to the exhaust gas line 12 via clamps 28. Conversely, there is a connection to the internal combustion engine only via the flexible hose line 22. The exhaust gas cooler 20 can therefore move relative to the internal combustion engine 14 and need not be supported jointly with it.

Since the exhaust gas cooler 20 is located at a distance from the internal combustion engine 14, there is no direct heat delivery from the internal combustion engine 14 into the exhaust gas cooler 20. Only the exhaust gas delivered via the exhaust gas recirculation line 16 heats the exhaust gas cooler 20. Overall, therefore, less heat need be dissipated by the exhaust gas cooler 20 than in the exhaust gas systems which are known from the prior art and in which the exhaust gas cooler is rigidly connected to the internal combustion engine and is in direct contact with it.

The lower heat delivery moreover enables the use of materials with relatively low resistance to heat. For example, the flexible hose 22 can be made of a nonmetallic material. Plastics are especially suitable for this purpose.

In order to be able to vary the cooling performance of the exhaust gas cooler 20, two separate heat exchangers 30, 32 are provided which form one flow channel 34, 36 each. A partition 38 separates the flow channels 34, 36 from one another. The two heat exchangers 30, 32 are arranged such that exhaust gas can flow through them parallel to one another.

In the flow direction of the exhaust gas downstream of the exhaust gas cooler, there is a flap 40 by means of which the flow channel 34 of the heat exchanger 30 can be closed. With the flap 40 closed, therefore, the entire amount of recirculated exhaust gas must flow through the heat exchanger 32; with the flap 40 open, the recirculated exhaust gas flows in parallel through the two heat exchangers 30, 32 of the exhaust gas cooler 20.

Opening the flap 40 therefore enlarges the entire cooler network surface available for cooling of the exhaust gas, the cooling performance of the exhaust gas cooler 20 is increased, and the recirculated exhaust gas is thus cooled more rapidly. This is especially advantageous in operating states of the motor vehicle in which especially large amounts of exhaust gas are formed or the exhaust gas has an especially high temperature, for example, in full load operation of the internal combustion engine 14.

If, conversely, there is only little or relatively cool exhaust gas being formed, it is expedient to close the flap 40. Due to the reduced available cooler network surface, the exhaust gas is cooled less rapidly with the flap 40 closed. The water vapor which is contained in the exhaust gas and which would condense if the exhaust gas were cooled too rapidly, therefore remains in the vapor phase. This is especially important when the recirculated exhaust gas is still being compressed by means of a turbocharger. Water droplets could damage specifically the compressor blades of this turbocharger.

The flap 40 can be controlled using different operating parameters of the internal combustion engine. For example, it is possible to directly measure the exhaust gas temperature and/or the exhaust gas mass flow and to control the flap 40 depending on the measurement results. The flap 40 can be furthermore controlled using the output of the internal combustion engine 14. At a high output with correspondingly high exhaust gas temperatures, the flap 40 is opened, whereas at low output it is closed.

In addition to the flap 40, the exhaust gas recirculation valve 24 is also used to control the exhaust gas recirculation. By changing the dynamic pressure in the exhaust gas system 10, the amount of recirculated exhaust gas can be set via the exhaust gas recirculation valve 24. The flap 40 and the exhaust gas recirculation valve therefore make it possible to adapt both the amount and also the temperature of the recirculated exhaust gas to the respective operating state of the internal combustion engine 14 and to the thermal load capacity of the components of the exhaust gas system 10.

1. A motor vehicle having an internal combustion engine and an exhaust gas system with an exhaust gas line by means of which exhaust gas from the internal combustion engine can be discharged, and an exhaust gas recirculation line by means of which exhaust gas from the exhaust gas line can be recirculated to an intake manifold of the internal combustion engine, in the exhaust gas recirculation line there being an exhaust gas cooler wherein the exhaust gas cooler can move relative to the internal combustion engine.

2. The motor vehicle according to claim 1 wherein the exhaust gas cooler is connected to the intake manifold of the internal combustion engine via a flexible line.

3. The motor vehicle according to claim 2, wherein the flexible line consists of a nonmetallic material.

4. The motor vehicle according to claim 1 wherein there is an exhaust gas recirculation valve in the flow direction of the recirculated exhaust gas downstream of the exhaust gas cooler for adjusting the gas mass flow of the recirculated exhaust gas.

5. The motor vehicle according to claim 1 wherein the exhaust gas cooler has at least two separate heat exchangers with one flow channel each, recirculated exhaust gas flowing through the two flow channels in parallel in at least one operating state of the exhaust gas cooler.

6. The motor vehicle according to claim 5 wherein there is at least one closing element by means of which an assigned flow channel can be closed.

7. A method for operating a motor vehicle with an internal combustion engine and an exhaust gas system, in which a partial exhaust gas flow is removed from an exhaust gas line of the exhaust gas system, is cooled by means of an exhaust gas cooler and is returned to the intake manifold of the internal combustion engine via a flexible line, wherein, depending on the operating state of the motor vehicle, at least one partial flow cross section of the exhaust gas cooler is closed.

8. The method according to claim 7 wherein at least one partial flow cross section of the exhaust gas cooler is closed when the exhaust gas cooler does not reach a specified exhaust gas mass flow and is cleared when a specified exhaust gas mass flow is exceeded.

9. The method according to claim 7 wherein at least one partial flow cross section of the exhaust gas cooler is closed when a specified exhaust gas temperature is not reached and is cleared when a specified exhaust gas temperature is exceeded.

10. The method according claim 7 wherein at least one partial flow cross section of the exhaust gas cooler is closed when a specified output of the internal combustion engine is not reached and is cleared when a specified output of the internal combustion engine is exceeded.

11. An exhaust gas recirculation line for an internal combustion engine of a motor vehicle comprising:
a fluid conveying conduit intercommunicating an exhaust manifold of said engine and a fuel inlet manifold, including a section providing first and second passageways;
first and second heat exchangers, each disposed in heat exchange relationship with one of said passageways and spaced from said engine, operative to cool a gas flowing therethrough; and
a valve selectively closing one of said passageways.

12. An exhaust gas recirculation line according to claim 11 wherein at least a portion of said conduit is flexible.

13. An exhaust gas recirculation line according to claim 11 wherein said conduit is formed of a nonmetallic material.

14. An exhaust gas recirculation line according to claim 11 including a valve disposed between said conduit and said fuel intake manifold.

15. An exhaust gas recirculation line according to claim 14 wherein said valve for selectively closing said one passageway is actuable responsive to a selected mass flow rate of said first intake valve.

16. An exhaust gas recirculation line according to claim 11 wherein said valve for selectively closing said one passageway is actuable responsive to a selected mode of operation of said engine.
